(19) United States
(12) Patent Application Publication
(10) Pub. No.: US 2026/0297300 A1
(43) Pub. Date: Oct. 1, 2026

(54) IDENTIFICATION MAT FOR IDENTIFYING ELECTRICAL COMPONENTS, AND METHOD FOR PRODUCING SAME

(71) Applicant: Phoenix Contact GmbH & Co. KG, Blomberg (DE)

(72) Inventors: Manuela PAUS, Münster (DE); Michael PETER, Lage (DE); Kilian KLAGES, Detmold (DE)

(21) Appl. No.: 19/478,848

(22) PCT Filed: Apr. 23, 2024
(86) PCT No.: PCT/EP2024/061017

§ 371 Date: Oct. 27, 2025

(30) Foreign Application Priority Data
May 4, 2023 (BE) BE2023/5360

(51) Int. Cl. C08K 11/00

(52) U.S. Cl. CPC C08K 11/00; C08K 2201/00

(57) ABSTRACT

An identification mat includes: a plurality of identification plates for identifying electrical components. The identification mat is made of a material that comprises a plastics material that includes at least one of: a polymeric secondary raw material, a biodegradable polymer, and a bio-based polymer. In an embodiment, the material includes a laser additive that allows the identification plates of the plurality of identification plates to be labeled by a laser.

### CROSS-REFERENCE TO PRIOR APPLICATIONS

This application is a U.S. National Phase application under 35 U.S.C. § 371 of International Application No. PCT/EP2024/061017, filed on Apr. 23, 2024, and claims benefit to Belgian Patent Application No. BE2023/5360, filed on May 4, 2023. The International Application was published in German on Nov. 7, 2024 as WO 2024/227658 A 1 under PCT Article 21(2).

### FIELD

The invention relates to an identification mat for identifying electrical components and to a method for producing such an identification mat.

### BACKGROUND

Such identification mats comprise a number of identification plates that serve for identifying electrical components, such as terminals, plugs or cables, but also electronic devices. An identification specific to the product to be identified is printed onto a labeling surface of an identification plate. For this purpose, the identification plates are produced together, for example as an identification mat, so that a plurality of identification plates can be labeled together in one labeling device, such as a printer.

Such identification mats or identification plates are typically supposed to meet the high requirements that are usually placed on the intended use within the industrial sector. In particular, they are regularly designed to withstand the effects of external environmental influences.

Identification mats with identification plates are typically made of a (thermoplastic) polymer or metal. Polymers established themselves very early on in the industrial sector as economical and easily moldable materials for various areas and tasks and cover a very wide range of possible applications. However, the problem with plastics materials is that they can have a high environmental impact. Moreover, the identification plates are sometimes subject to frequent replacement, for example after maintenance or product-specific name changes, and can therefore lead to a high volume of waste.

In an embodiment, the present invention provides an identification mat, comprising: a plurality of identification plates for identifying electrical components, and a material that comprises a plastics material comprising: a polymeric secondary raw material, a biodegradable polymer, and/or a bio-based polymer.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1 shows a perspective schematic view of an identification mat;

FIG. 2 shows a perspective schematic view of another identification mat;

FIG. 3 shows a plan view of the transverse side of the identification mat shown in FIG. 2;

FIG. 4 shows a perspective schematic view of an identification mat in an alternative embodiment;

FIG. 5 shows a schematic sectional view of a printer for labeling an identification mat; and

FIG. 6 shows a method for producing an identification mat.

### DETAILED DESCRIPTION

In an embodiment, the present invention improves the environmental compatibility in connection with the identification of electrical components.

Accordingly, an identification mat, in particular for identifying electrical components and comprising one or more identification plates is provided, wherein the identification mat is made at least partly, in particular completely, from a material that comprises (or consists of) a plastics material which is a polymeric secondary raw material and/or a biodegradable polymer and/or a bio-based polymer (e.g., produced from renewably and/or biologically generated synthesis gas and/or liquids and/or more generally reactants).

This is based on choosing from a selection of plastics materials that are used, either on their own or in combination, to increase the environmental compatibility of an identification mat or of identification plates and to thus reduce their impact on the environment. As a result, an identification mat with a significantly improved environmental balance is provided. The invention employs a material approach to reduce the environmental impact. In particular, the invention shifts away from the approach of replacing a plastics material with another material, such as a metal. Furthermore, existing systems for identification can continue to be used without any changes being necessary.

This is achieved by providing a selection of plastics materials that are recycled and/or biodegradable and/or produced from renewable raw materials. The selection is therefore not limited to a specific plastics material from those mentioned above, and therefore they can also be combined with one another.

The material can consist of at least one of the aforementioned plastics materials, but may also contain other substances added to the material, such as additives or other polymers or polymer components. Furthermore, composite materials can also be used for the material. Furthermore, it is possible to mix the aforementioned plastics materials with other components, for example additives or primary polymers.

The identification mat described herein makes it possible not only to significantly reduce the environmental impact but also to significantly reduce the impact on raw material resources. Furthermore, the identification mat can be used to meet the sometimes increased requirements for the usability of the corresponding identification plates, e.g., with regard to temperature resistance, which are usually realized with primary materials. However, identification plates are typically replaced more frequently than the components they mark. Based on this finding, it has been shown that the above-mentioned materials, which are more environmentally friendly than conventional engineering thermoplastics made from fossil raw materials, can be used for identification plates.

The material can comprise a laser additive. The laser additive can be designed to make the identification mat and/or the identification plates capable of being labeled by means of a laser after the production of the identification mat. For example, the laser additive can be activated by a laser. The laser additive can be activated by means of a laser and thus enable or facilitate, in particular enhance, the creation of a label, e.g., an image and/or text, on the surface of an identification plate. Moreover, the laser additive can be designed to compensate for fluctuations in the identification quality resulting from a previous recycling process of one or more material components. The laser additive thus enables particularly good and even labelability of the identification plates of the identification mat after their production. In particular, this can reduce the amount of waste generated from, for example, incorrectly labeled identification plates, thus further improving the environmental balance. Furthermore, this can also make it possible to use certain particularly environmentally friendly materials for identification plates. The material can form a plastic matrix in which the laser additive is embedded. The laser additive can be distributed throughout the entire material. The laser additive is mixed into the material, for example.

For example, a color of the laser additive can be changed using a laser. In the present case, a changeover and/or a color change can be enabled, in particular enhanced, by the laser additive. For example, a previously colorless laser additive becomes colored by laser light. This allows for good labelability. Alternatively or additionally, the laser additive can increase the absorption capacity of the plastic matrix for the laser light.

The labeling process is preferably a printing process and can be done by a labeling device, preferably a printer. The printer can contain a laser. In one example, the laser is designed as an infrared laser, in particular with a wavelength of 1064 nm.

The laser additive can be introduced into the material, in particular into the plastics material, via a masterbatch. The masterbatch is, for example, a concentrate of one or more additives, in the present case of the laser additive, in the form of a plastic-based granulate. The concentration of the additives in the masterbatch is optionally higher than their concentration in the desired end product, here the identification mat. The masterbatch allows the provision of pre-concentrated laser additives in the form of granulates that are mixed into the plastics material (raw polymer).

It is also possible to introduce the laser additive via extrusion, or the like, of a compound, also known as compounding. This differs from the masterbatch in that it is used in the subsequent processing without further dilution of the concentration of the laser additive in the plastics material, since the laser additive is already present in the desired final concentration.

The introduction of the laser additive via a masterbatch or by compounding enables a particularly homogeneous distribution of the laser additive and thus a particularly efficient and uniform laser marking with a suitable laser.

Optionally, the material comprises a plurality of different plastics materials. Each of the number of different plastics materials can be a polymeric secondary raw material, made from biologically produced synthesis gas, from biologically produced synthesis liquids and/or from biologically produced synthesis reactants, and/or be biodegradable.

For example, the material comprises a polymeric secondary raw material and a renewable raw material, or the material comprises a polymeric secondary raw material and a biodegradable raw material, or the material comprises a renewable raw material and a biodegradable raw material, or the material comprises a polymeric secondary raw material and a renewable raw material and a biodegradable raw material. Optionally, the same plastics material of the material can be both a polymeric secondary raw material and a renewable raw material, or the same plastics material is both a polymeric secondary raw material and a biodegradable raw material, or the same plastics material is both a renewable raw material and a biodegradable raw material, or the same plastics material is a polymeric secondary raw material as well as a renewable raw material and a biodegradable raw material. This allows particularly environmentally friendly identification mats to be provided.

The polymeric secondary raw material can be a conventional and/or chemically recycled thermoplastic. Conventionally recycled thermoplastics are, for example, mechanically recycled and/or produced by melting. Conventionally recycled thermoplastics typically differ from corresponding primary, i.e., non-recycled, thermoplastics by their correspondingly shorter polymer chains. Conventionally recycled materials regularly differ from standard materials by their additional thermal stress, as the polymers are typically melted at least one more time than the original standard material. If additional granulation processes are still provided before the material is processed/used for the second time, the additional thermal stress/damage may be further increased. Certificates for a reduced CO₂ content are usually issued for chemically recycled materials. Usually, this can be used to subsequently prove a corresponding CO₂ reduction.

For example, at least 25 wt. % of the material consists of the plastics material that is a conventionally and/or chemically recycled thermoplastic, in particular at least 50 wt. % or even 100 wt. %. This enables a substantial improvement in the environmental balance, in particular the so-called CO₂ footprint of the material.

Optionally, the polymeric secondary raw material is a conventionally recycled thermoplastic, which can be an engineering thermoplastic. For example, the polymeric secondary raw material is a conventionally recycled thermoplastic and/or is selected from the group of polycarbonate, polyamide, polyethylene, polyethylene terephthalate, polyvinyl chloride and polypropylene. These materials provide particularly good properties for many fields of use.

Optionally, 10 to 100 wt. % (or 10 to 80 wt. %) of the material consists of the plastics material produced from renewably and/or biologically generated synthesis gas and/or liquids and/or reactants. This allows a particularly resource-saving identification mat to be provided.

For example, the plastics material of the material is produced from renewably and/or biologically generated synthesis gas and/or liquids and/or reactants, wherein the renewable raw material is selected from sugar, starch, protein, cellulose, lignin, fat and/or vegetable oil, in particular castor oil and rapeseed oil. This generally includes renewable or biologically produced synthesis gases and synthesis liquids that are used as reactants for formulating/representing the plastics material (e.g., biogas, biomethanol, bioliquids, organic waste, etc.). This provides particularly environmentally friendly and at the same time robust identification plates for identification purposes.

The plastics material of the material can be produced from renewably and/or biologically generated synthesis gas and/or liquids and/or reactants and can be in the form of polylactide, polyhydroxyalkanoate, cellulose derivative, in particular cellulose ester or cellulose butyrate, polyethylene, starch derivative, polyurethane, TPU, TPS, polycarbonate, polyamide, polyethylene, polyethylene terephthalate, polyvinyl chloride, polybutylene terephthalate, polyester and polypropylene, as well as their blends and copolymers. This also allows for an environmentally friendly and at the same time robust identification mat.

Optionally, the plastics material of the material is biodegradable and can be in the form of polybutylene adipate terephthalate, polyhydroxyalkanoate, polylactide, starch blend or polyester. Thus, the printed or unprinted identification plates and any remnants of the identification mat can be easy to compost after removal, in particular after breaking off the identification plates from the identification mat after use, optionally also with notification of additives for composting. This in particular makes it possible to dispose of it in a very environmentally friendly manner.

For example, the identification plates of an identification mat are extended in rows relative to one another along two dimensions that are perpendicular to one another. This enables particularly reliable and uniform labeling of the identification mat after its production in a dedicated printer and thus a particularly low waste requirement due to incorrect labeling.

In one embodiment, the identification plates are molded onto one or more transverse webs. In particular, a number of identification plates are molded onto one (common) transverse web. The one transverse web and the number of identification plates molded onto it can form an identification unit. In this way, a large number of identification plates per identification mat are (each) connected to one another to form a few identification units.

The identification units can be connected to one another via a frame. Such a design of identification units connected via a frame facilitates (joint) labeling in a dedicated labeling device, such as a printer.

Optionally, the identification plates are connected to the rest of the identification mat via a predetermined breaking point. The predetermined breaking point can be in the form of a reduction of the material, e.g., a material taper or a perforation in the connection area.

The predetermined breaking point enables simplified separation, in particular breaking the identification plates off from the identification mat, in particular after the identification plates have been labeled, and thus easy handling. For example, predetermined breaking points can be provided between a transverse web and the identification plates molded onto it.

The identification mat can have guide means for guiding the identification mat in a printer. The guide means are in particular arranged on the frame. The guide means serve to hold and/or convey the identification mat during printing by a printer. For this purpose, the printer can have a corresponding holder that can be engaged with the guide means of the identification mat.

The identification mat can be rigid. The identification mat is, for example, a panel.

According to one aspect, a method for producing an identification mat, in particular for identifying electrical components, comprising one or more identification plates is specified. The method comprises providing a material comprising a plastics material, wherein the plastics material is (or will be) produced by recycling a thermoplastic, is bio-based, e.g., is (or will be) produced from renewably and/or biologically generated synthesis gas(es) and/or liquid(s) and/or reactant(s), and/or is biodegradable. The method further comprises shaping the identification mat at least partly, optionally completely, from the material. As regards the advantages, reference is made to the above statements relating to the identification mat. The method can be used to design the identification mat in accordance with any of the embodiments described herein.

The material can comprise a laser additive which enables the identification plates to be labeled by means of a laser, in particular by means of an infrared laser, after the identification mat has been produced. As regards the advantages, reference is made to the above statements.

Optionally, the plastics material is produced by chemically recycling a thermoplastic. This allows the plastics material to be a particularly high-performance and high-quality plastics material while at the same time having a particularly positive environmental balance. An alternative or additional conventional recycling process may include shredding. Chemical recycling includes, for example, solvolysis, depolymerization, pyrolysis and/or gasification. This enables particularly high-quality recycled thermoplastics to be achieved.

The identification mat can be shaped by injection molding. This enables particularly easy production of large quantities.

According to one aspect, a method for producing labeled identification mats is provided. The method comprises providing an identification mat according to any embodiment described herein, in particular by producing an identification mat according to the method described above in any embodiment, and printing the identification plates with a printer, in particular by means of a laser of the printer.

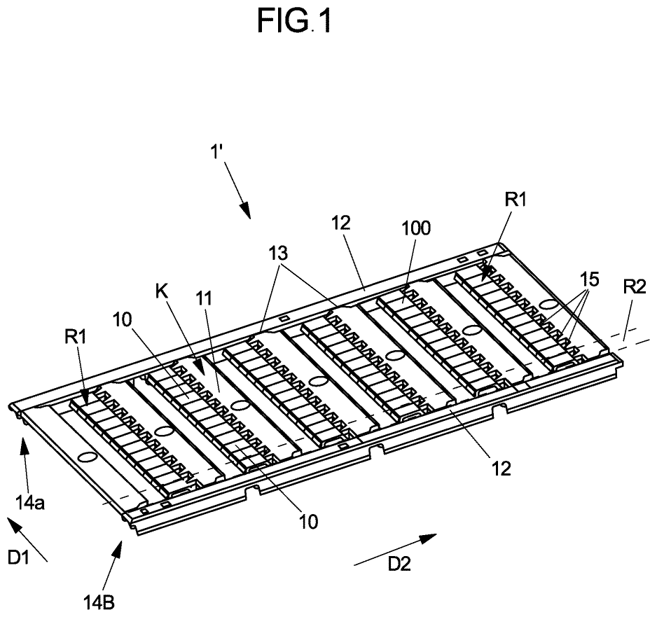

FIGS. 1 to 4 show various identification mats 1, 1′, 1″, each with a number of identification plates 10 for identifying, for example, electrical components.

The identification mats 1, 1′, 1″ are generally at least partly made of a material comprising a plastics material that (a) is a polymeric secondary raw material and/or (b) is produced from renewably and/or biologically generated synthesis gas and/or liquids and/or reactants, and/or (c) is biodegradable.

The polymeric secondary raw material is, for example, a conventionally recycled thermoplastic (e.g., mechanically and/or by melting) and/or a chemically recycled thermoplastic. For example, at least 25 wt. % of the material consists of the polymeric secondary raw material. The polymeric secondary raw material can be an engineering thermoplastic, in particular polycarbonate, polyamide, polyethylene, polyethylene terephthalate, polyvinyl chloride or polypropylene. Thermoplastics have the advantageous property of good formability and processability since they can soften to the point of flowing, for example, when heat is applied, and are therefore easy to shape. After a cooling phase, they become solid again and retain their shape.

Industrial plastics waste is often available in large quantities and is usually pure-grade, which means that sorting or cleaning effort can be minimized and it is then immediately available for recycling. For example, it is comminuted and can then be reused to form the identification mats 1, 1′, 1″. Optionally, used identification plates are used to produce the material.

Furthermore, 10 to 100 wt. % of the material can consist of the plastics material produced from renewably and/or biologically generated synthesis gas and/or liquids and/or reactants. The renewable raw material can be sugar, starch, protein, cellulose, lignin, fat and/or vegetable oil. In particular, the renewable raw material can be castor oil. Bio-based polymers can also be referred to as engineering biopolymers and can be produced from biogenic raw materials, preferably renewable plant-based raw materials. Biowaste can also be used for this purpose, whereby sustainability is or can be further increased. Renewable raw materials, in particular rapeseed and corn, for example, are available and exist or can be grown in large quantities. A bio-based polymer that is also biodegradable is particularly environmentally friendly. Examples of bio-based polymers are polybutyrate adipate terephthalate (PBAT), so-called starch-based biodegradable blends or polylactide (PLA), polyhydroxyalkanoates (PHA), cellulose derivatives, e.g., cellulose esters (CA) and cellulose butyrate (CAB), so-called biodegradable polyesters as well as starch derivatives. They also include bio-polyethylene and can correspond to the properties of a conventional polyethylene based on a fossil raw material (primary polymer).

Furthermore, the plastics material of the material can be biodegradable and can be in the form of, for example, polybutylene adipate terephthalate, polyhydroxyalkanoate, polylactide, starch blend or polyester. A biodegradable portion of the material can be detected by carbon detection. A material is biodegradable in particular when such degradation takes place by means of a chemical process in which microorganisms present in the environment convert the material into natural substances such as water, carbon dioxide and compost (artificial additives in particular not being required). The process of biodegradation depends on the environmental conditions (e.g., location or temperature), the material and the applications. Biodegradable polymers include PBAT, PLA and PHA, among others.

The biodegradable plastics materials can be enriched with additional properties by means of additives based on fossil raw materials or renewable raw materials so that, compared with conventional polymers, further potentially specific material properties can be produced with regard to the desired labelability and/or printability, light resistance, water vapor permeability or biodegradability. These polymers therefore open up a wide range of uses through specifically adapting the material.

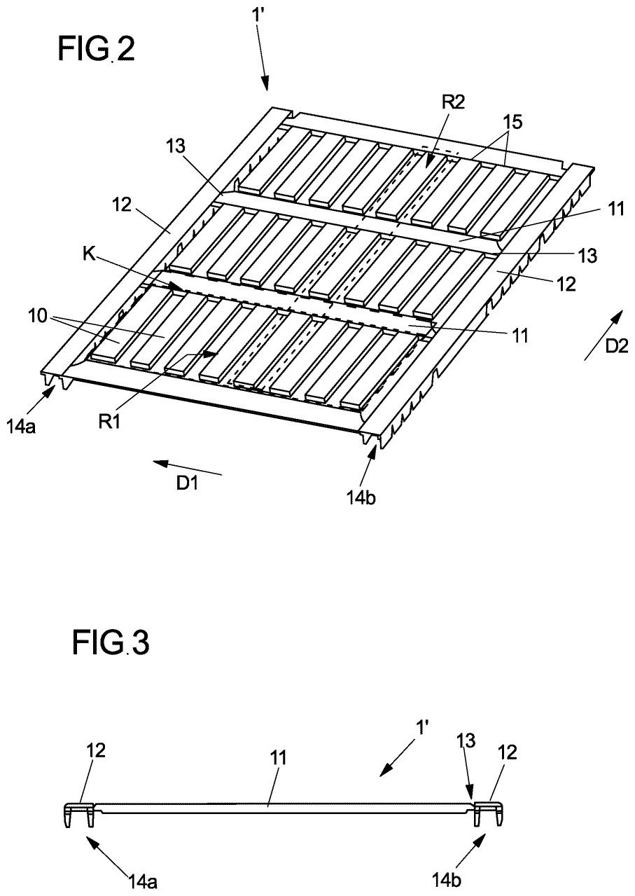

In the examples in FIGS. 1 and 2, the material of the respective identification mat 1, 1′ consists of polyamide.

The identification mats 1, 1′, 1″ each comprise a large number of identification plates 10. The identification plates 10 each have a labeling surface 100 which can be labeled, for example in a printer 2.

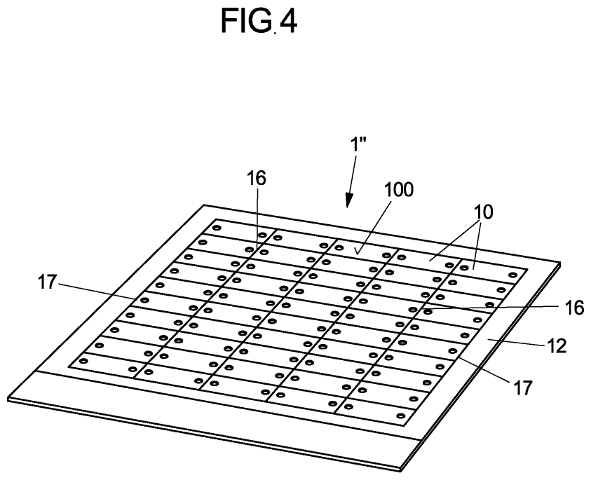

The identification plates 10 are arranged in a number of rows R1 extending along a (first) dimension D1. The rows R1 of identification plates 10 are further arranged in rows R2 along a (second) dimension D2 perpendicular to the (first) dimension D1. The identification plates 10 can be directly adjacent to one another in both dimensions D1, D2 (as in the example of identification mat 1″ according to FIG. 4), be lined up at a distance from one another in both dimensions D1, D2 (as in the example of identification mat 1′ according to FIGS. 2 and 3) or be directly adjacent to one another in one dimension D1 and be lined up at a distance from one another in the other dimension D2 (as in the example of identification mat 1 according to FIG. 1).

In the exemplary embodiments according to FIGS. 1-3, a number of identification plates 10, specifically a row R1 of identification plates 10, are (each) arranged on, in the present case molded onto, a transverse web 11. The transverse webs 11 each form, together with the identification plates 10 arranged along a row R1, an identification unit K. The identification units K are arranged in a row one behind the other and spaced from one another, namely along the (second) dimension D2 in the example shown. However, it is also possible for the identification units K to be directly adjacent to one another.

The identification units K are connected to one another via a frame 12. The frame 12 extends laterally, in particular on both sides, along the identification units K, in particular along the transverse sides of the identification units K, namely along the (second) dimension D2 in the example shown.

In the example shown, the identification mat 1 has guide means 14a, 14b for guidance in a printer 2 (see FIG. 5), in which the identification plates 10, in particular their labeling surfaces 100, can be printed. In the present case, the guide means 14a, 14b are arranged on the frame 12. The identification plates 10 are arranged between the guide means 14a, 14b.

In the present case, the guide means 14a, 14b are each designed in the form of a runner. The shown parallel arrangement of the guide means 14a, 14b enables a particularly secure, in particular tilt-and twist-proof, guidance of the identification mat 1 in the printer 2.

The identification mat 1′ according to FIGS. 2 and 3 further has a predetermined breaking point 13 in the connection area between the frame 12 and the identification unit K, in particular between the frame 12 and the transverse web 11 of the respective identification unit K. The predetermined breaking point 13 is designed in the form of a material reduction. The predetermined breaking point 13 enables easy removal of an identification unit K from the frame 12, in particular after labeling in a printer 2.

Furthermore, in the example shown, further predetermined breaking points 15 are provided between a transverse web 11 and the identification plates 10 molded onto it. In the present case, they are also designed in the form of a material taper. These predetermined breaking points 15 enable the individual identification plates 10 to be easily separated from the respective transverse web 11, in particular after the identification plates 10 have been printed in the printer 2.

The individual identification plates 10 of the identification mats 1, 1′ of FIGS. 1-3 each have latching elements. The latching elements allow the identification plates 10 to be latched to an electrical component or the like.

In the identification mat 1″ shown in FIG. 4, the identification plates 10 are directly connected to one another in both dimensions D1, D2. The identification plates 10 are embedded in a frame 12 and directly connected to the frame 12. In this variant, the identification mat 1″ is designed in particular as a (flat) panel, in particular as a plate panel.

Linearly extending predetermined breaking points 16 in the form of predetermined breaking lines are provided between the identification plates 10 along the dimensions D1, D2 that are perpendicular to one another. Furthermore, predetermined breaking points 17 in the form of predetermined breaking lines are provided between the frame 12 and the identification plates 10. This ensures that the identification plates 10, which are designed to be rectangular herein, can be easily broken out.

The identification plates 10 of the identification mat 1″ according to FIG. 4 each comprise at least one, here two, openings, by means of which the individual identification plates 10 can be attached to a (e.g., electrical) component.

In the examples shown, the identification mats 1, 1′, 1″ each comprise a number of identification plates 10. However, it is also possible for an identification mat 1, 1′, 1″ to be designed in the form of a single identification plate 10 and/or to comprise only one identification plate 10.

FIG. 5 shows the already mentioned printer 2, with which an identification mat 1 can be labeled. The printer 2 has a printing unit which is designed here in the form of a laser 21, by means of which the identification mat 1 can be printed.

Alternatively or additionally, the printing unit can provide thermal transfer printing or inkjet printing. In one example, the laser 21 is designed as an infrared laser, in particular with a wavelength of 1064 nm.

During laser marking, a color and/or contrast change can be generated by laser radiation on the relevant surface, here the labeling surface 100 of the respective identification plate 10. This happens when a material in the material of the labeling surface 100 absorbs the laser energy. The material of the identification mat 1 and thus of the identification plates 10 or labeling surface 100 can in particular comprise a laser-sensitive additive in the form of a laser additive which can be activated by a laser (through absorption of the laser energy). The laser additive is designed to cause a, in particular, local and visible discoloration when exposed to laser irradiation.

The laser additive is designed to absorb the laser light and can be an organic compound or an inorganic compound. For example, the laser additive is a pigment, in particular a color pigment. Preferably, the laser additive is designed to absorb light in an absorption range with a wavelength between 400 and 1100 nm.

The laser additive(s) is/are matched in particular to the wavelength of the beam source used, in this case the laser. In other words, the laser additive is designed to absorb light in an absorption range that corresponds to the emission range of the laser. In one example, the laser is designed as an infrared laser, in particular with a wavelength of 1064 nm. Accordingly, the laser in this example is designed to absorb light in the infrared range, in particular light with a wavelength of 1064 nm.

For example, the absorption ranges of the laser additive and the plastics material differ from one another. Optionally, the absorption ranges of the laser additive and the plastics material overlap at least partly.

The discoloration of the material at the points of laser irradiation can occur, for example, by darkening the corresponding plastics material or the plastics material composition in the material of the identification mat 1, in particular by burning plastics materials (carbonization) by means of laser irradiation. For this purpose, the material can, for example, contain titanium dioxide with a tin/antimony oxide coating as an additive.

With the help of the laser additive, it is possible to obtain defined and clearly visible labels or markings in a targeted manner (i.e., under defined laser irradiation).

The printer 2 has an opening 22. In the present case, the opening 22 serves for inserting the respective identification mat 1, 1′, 1″.

The printer 2 further comprises a holder 23 on which the identification mat 1 can be arranged and is arranged according to FIG. 5. In the example shown, the holder 23 is movable relative to a housing 20 of the printer 2. In the present case, the identification mat 1 arranged on the holder 23 can be displaced relative to the laser 21 by a relative movement of the holder 23 relative to the housing 20.

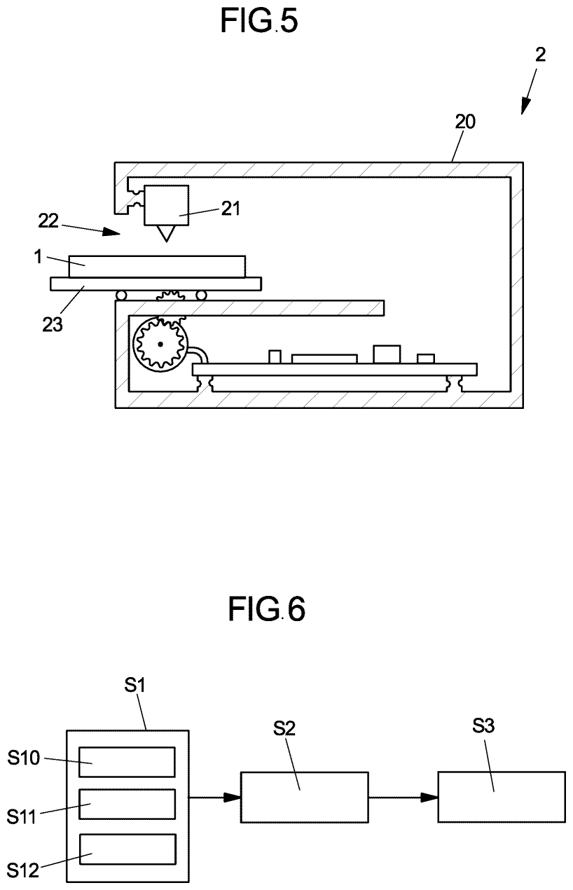

FIG. 6 shows a method for producing an identification mat (e.g., one of the identification mats 1, 1′, 1″ according to FIGS. 1-4), in particular for identifying electrical components, and for producing such a labeled identification mat. The method comprises the following steps.

In a first step, step S1, a material is provided. The material comprises or consists of a plastics material. The plastics material is produced in a step S10 by recycling, in particular chemically recycling, a thermoplastic, is produced from a renewable raw material in a step S11, and/or provided in the form of a biodegradable plastics material in a step S12. The chemical recycling of the thermoplastic in step S10 involves, for example, solvolysis, depolymerization, pyrolysis and/or gasification. To avoid repetition, reference is made here to the possible properties and compositions of the material described elsewhere herein.

In a further step S2, the identification mat 1, 1′, 1″ is shaped at least partly, in particular completely, from the material, for example by primary shaping, in particular by injection molding, and/or by reshaping. For shaping, an injection mold can be provided into which the material is introduced by plastics injection molding. The identification mat 1, 1′, 1″ is then ready.

The material can comprise an additive which enables labeling, in particular printing, of the identification plates 10 by means of a laser, in particular an infrared laser.

In order to label the identification mat 1, the method further comprises a further step S3 in which at least the identification plates 10 of the identification mat 1 are printed with a printer 2.

It should be noted that the method can involve recycling a polymer by breaking it down by pyrolysis into its original monomers or other materials that can be recycled, in particular petrochemically. The latter include methanol and synthesis gases, for example. In order to obtain monomers, the recycling process can be carried out with a pure-grade plastics material. This makes it possible to recover petrochemical raw materials as well as monomers. Furthermore, it is possible to use degradative extrusion to obtain gases, waxes and oils that are equivalent to raw materials and can be recycled accordingly from, in particular mixed, plastics waste. It is thus also possible to recycle polymers whose materials are difficult to separate.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

1′; 1; 1″ Identification mat
10 Identification plate
100 Labeling surface
11 Transverse web
12 Frame
13 Predetermined breaking point
14a, 14b Guide means
15 Predetermined breaking point
16 Predetermined breaking point
17 Predetermined breaking point
2 Printer
21 Laser
22 Opening
23 Holder
D1, D2 Dimension
K Identification unit
R1, R2 Row

1: An identification mat, comprising:
a plurality of identification plates for identifying electrical components, and
a material that comprises a plastics material, comprising:
a polymeric secondary raw material,
a biodegradable polymer, and/or
a bio-based polymer.

2: The identification mat of claim 1, wherein the material comprises a laser additive configured to allow the identification plates of the plurality of identification plates to be labeled by of a laser.

3: The identification mat of claim 2, wherein a changeover or color change is enhanced or enabled by the laser additive.

4: The identification mat of claim 1, wherein the material comprises a plurality of different plastics materials,
each of which is a polymeric secondary raw material, is produced from renewably and/or biologically generated synthesis gas and/or liquids and/or reactants, and/or is biodegradable.

5: The identification mat of claim 1, wherein the polymeric secondary raw material is a conventionally recycled thermoplastic and/or a chemically recycled thermoplastic.

6: The identification mat of claim 5, wherein the material comprises at least 20 wt. %, of plastics material which is the conventionally recycled thermoplastic and/or the chemically recycled thermoplastic.

7: The identification mat of claim 5, wherein the polymeric secondary raw material is a conventionally and/or chemically recycled thermoplastic which is an engineering, standard or high-performance thermoplastic and/or thermoplastic elastomer.

8: The identification mat of claim 1, wherein 10 to 100 wt. % of the material comprises the plastics material produced from the synthesis gas, the synthesis liquids and/or synthesis reactants, produced from renewably bio-based polymer and/or biologically from-bio-based polymer.

9: The identification mat of claim 8, wherein the plastics material of the material is produced from renewably and/or biologically generated synthesis gas and/or liquid and/or reactant, made from sugar, starch, protein, cellulose, lignin, fat and/or vegetable oil.

10: The identification mat of claim 1, wherein the plastics material of the material is produced from renewably generated synthesis gas, biologically generated synthesis gas, renewably generated synthesis liquid, biologically generated synthesis liquid, renewably generated synthesis reactant, and/or biologically generated synthesis reactant, and
wherein the plastics materials comprises: polylactide, polyhydroxyalkanoate, cellulose derivative, polypropylene, and/or blends and copolymers of the foregoing.

11: The identification mat of claim 1, wherein the plastics material of the material is biodegradable and comprises polybutylene adipate terephthalate, polyhydroxyalkanoate, polylactide, starch blend, or polyester.

12: The identification mat of claim 1, wherein the identification plates of the plurality of identification plates are arranged in rows relative to one another along two dimensions that are perpendicular to one another.

13: The identification mat of claim 1, wherein the identification plates of the plurality of identification plates are molded onto one or more transverse webs.

14: The identification mat of claim 1, wherein the identification plates of the plurality of identification plates are each connected to a remaining identification mat via a predetermined breaking point.

15: A method for producing the identification mat of claim 1, the method comprising:
providing the material comprising the plastics material, wherein the plastics material is at least one of produced by recycling a thermoplastic, is bio-based, and/or is biodegradable; and
shaping the identification mat from the material, at least in part.

16: The method of claim 15, wherein providing the material comprises adding a laser additive.

17: The method of claim 15, wherein the plastics material is produced by chemically recycling a thermoplastic, and
wherein chemically recycling the thermoplastic comprises solvolysis, depolymerization, pyrolysis and/or, gasification.

18: The method of any claim 15, wherein the shaping of the identification mat is carried out by injection molding.

19: A method for producing labeled identification mats, comprising:
providing the identification mat of claim 1; and
printing identification plates of the plurality of identification plates with a laser.

20: The identification mat of claim 6, wherein the material comprises at least at least 25 wt. % of the plastics material.
